(19) United States
(12) Patent Application Publication
(10) Pub. No.: US 2022/0207466 A1
(43) Pub. Date: Jun. 30, 2022

(54) SHIPPING BOXES CONFIGURED FOR AUTOMATED INVENTORY SYSTEM

(71) Applicant: Walker Atherton Jones, San Antonio, TX (US)

(72) Inventor: Walker Atherton Jones, San Antonio, TX (US)

(21) Appl. No.: 17/566,911

(22) Filed: Dec. 31, 2021

Related U.S. Application Data
(60) Provisional application No. 63/133,206, filed on Dec. 31, 2020.

(51) Int. Cl. G06Q 10/08; B65D 5/54; B65D 5/42

(52) U.S. Cl. CPC G06Q 10/087; B65D 5/542; B65D 5/4208; B65D 5/4204; B65D 5/4212; B65D 5/4295

(57) ABSTRACT

A shipping box is made of a material sufficiently rigid to serve as a shipping container for product packages and is shaped so as to be able to form an enclosed shipping box having a top wall, a bottom wall, and four sidewalls interconnecting the top and bottom walls. The enclosed shipping box is configured such that the four sidewalls have at least one line of perforations predetermined to permit the top wall and predetermined top portions of the four sidewalls to selectively be removed so that portions of the shipping box remaining after the top wall and top portions of the sidewalls are removed form a display case permitting visibility and accessibility for product packages shipped using the enclosed shipping box.

### CROSS-REFERENCE TO RELATED APPLICATIONS

This application claims the benefit of priority to U.S. Provisional Patent Application No. 63/133,206 filed Dec. 31, 2020. Said U.S. Provisional Patent Application No. 63/133,206 is incorporated by reference in the entirety herein.

### BACKGROUND

### Field of the Art

A container box made of material sufficiently rigid to be used for shipping products is configured to permit a predetermined portion(s) of the box to be selectively removable so that product units remaining in the container box can be viewed as accessible and can be taken out for purchase by customers in a retail environment and/or for removal by employees in an order distribution center collecting items to fulfill an online order. The configuration of the container box permits the number of product units remaining in the container box to be monitored to provide data for an automatic inventory control system, using any of various exemplary sensing systems and methods.

### Discussion of the State of the Art

Conventional methods of updating and/or confirming inventory data typically rely on manual-based methods in which a person using, for example, a scanning device to identify a product code then counts the number of units remaining on display shelves to provide data for determining or confirming remaining inventory for each product. Even if products are shipped as packaged together in a shipping container, such containers are typically stored in a storage area different from the display shelf area and most products must be carried from a storage area to the display shelves to replenish units available for customers to take for purchase. Additionally, containers for packaging and displaying consumer products come in a large variety of sizes. Such variety often results in inefficiencies in shipping and storing consumer products.

### SUMMARY

A key aspect of the present invention is that containers used for shipping and/or storing units of consumer products are configured so that the consumer products can be easily displayed, for example, on a shelf in a retail display area, within their original shipping container, thereby eliminating the need to replenish display shelves by removing product units from shipping containers in a storage area and moving such replacement product units from the storage area to the display shelf area.

Another feature of the present invention is that the shipping containers described herein are also configured so that inventory of items remaining on the display shelves can be automated, thereby eliminating the conventional manual inventory method involving a person using a scanner and making a manual count of the number of product items remaining.

In some preferred exemplary embodiments, for each product, a set of standard shipping box sizes based on standard shipping pallet dimensions provides more efficiency in shipping consumer products. Preferably the consumer product packages also have dimensions having a ratio(s) of the internal dimensions of the standard shipping box sizes so that a predetermined number of consumer packages essentially completely fills a standard shipping box with little or no spacing material needed to completely fill space remaining in the shipping box.

To achieve the dual goals of (1) permitting the consumer products to be displayed while still within the shipping container and (2) providing a mechanism for automatic inventory counting, the standardized shipping boxes of the invention include perforations intended to permit and facilitate easy removal of sections of cardboard or other material such as plastic comprising the shipping container at, for example, the top of the shipping box, for exposure of the enclosed shipped products to consumers on shopping shelves can view the consumer item packages inside the shipping container. Thereby efficiency is inherent in presenting the products to consumers since the consumer product packages are presented in their original shipping box and do not have to be moved to display shelves from shipping boxes stored in a separate storage area.

Although described above as used in a consumer display area, it is noted that the methods of the present invention are also relevant in other scenarios such as distribution centers in which personnel locate product items ordered, for example, online or via a telephone order, to collect such ordered items and prepare them for shipment or delivery to the consumer placing the order.

To achieve the second goal of automated inventory counting, various mechanisms are described herein that are based on the shipping containers modified in accordance with the concepts of the present invention. Since the standardized shipping boxes are intended to be used to hold products for display to consumers, automatic inventory control input data is provided by detecting the number of units remaining in a shipping box. For example, in some exemplary embodiments, the detection of remaining units is achieved by including holes in the bottom wall of the standardized shipping boxes so that the number of remaining units can be sensed by, for example, sensors located below the box for purpose of detecting when a consumer has selected and removed a product from the standardized shipping box. This and other exemplary methods of sensing remaining units will be described in more detail below.

The standardized shipping boxes can also be customized based on characteristics of each intended product to also include holes predetermined in size and location for decreasing weight of the shipping box, permitting partial visual inspection of the contents of the shipping box without actually opening the box, or possibly permitting ventilation requirements of a product such as produce, while maintaining structural strength of the standardized shipping box including, in some exemplary embodiments, sufficient strength to permit stacking of the shipping boxes during shipping and/or storage.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1A and FIG. 1B illustrate various concepts of some exemplary embodiments, including the selective removal of predetermined portions of a shipping container so as to provide visibility to product package units remaining in the shipping/display container.

FIG. 1C and FIG. 1D illustrate how the shipping containers provide visibility and accessibility of product packages inside the shipping containers.

FIG. 1E demonstrates how a shipping box containing multiple layers of product packages could have a corresponding perforation indicator for each layer.

FIG. 1F demonstrates how other perforation patterns, such as a simple diagonal pattern, could be used as alternative to the stair-step pattern exemplarily shown in FIG. 1A through FIG. 1E.

FIG. 1G demonstrates how preset holes in the bottom wall of a shipping container could be used for various types of sensors located in a shelf or floor below the shipping container.

FIG. 2 illustrates how holes in the bottom surface of the shipping box could be part of an automatic inventory monitoring system that is a low-technology method using a spring-loaded string or wire.

FIG. 3 exemplarily illustrates how a spring or a spring-loaded plunger could be used to push remaining product packets forward as product packages are sequentially removed from the shipping container and how such mechanisms could be used for automatically counting the number of product packet units remaining in the shipping container.

FIG. 4 illustrates how the bottom wall of a shipping container could be modified to incorporate two or more channels inside the shipping container to provide an alternate method of mounting the shipping container for display

FIG. 5 illustrates an alternate modification to the bottom wall in which the reinforced channels are formed outside the shipping container, which provides a benefit of possibly eliminating the need to use a shipping pallet, to thereby save weight and volume during shipping.

FIG. 6 illustrates an exemplary flowchart of processing for inventory control using concepts of the standardized shipping boxes of the present invention.

FIG. 7 illustrates an exemplary computing architecture that supports an embodiment of the inventive disclosure.

FIG. 8 illustrates components of a computing device that supports an embodiment of the inventive disclosure.

### DETAILED DESCRIPTION

The inventive system and method (hereinafter sometimes referred to more simply as “system” or “method”) described herein relates to improving efficiency in providing consumer products for display in retail stores, including large-scale retailers, such a Costco retail store, and grocery stores that sometimes display products in bulk units, as well as improving efficiency in storing products in large storage or distribution centers, such as might be used by online marketers such as Amazon or a regional distribution center for parts. However, the concepts of the present invention are not limited to large-scale operations, since they equally apply to smaller operations that wish to maintain a desired number of units of specific products in inventory, whether or not that inventory is stored in a separate storage area and whether or not the products are displayed on shelves for evaluation by consumers in a retail establishment.

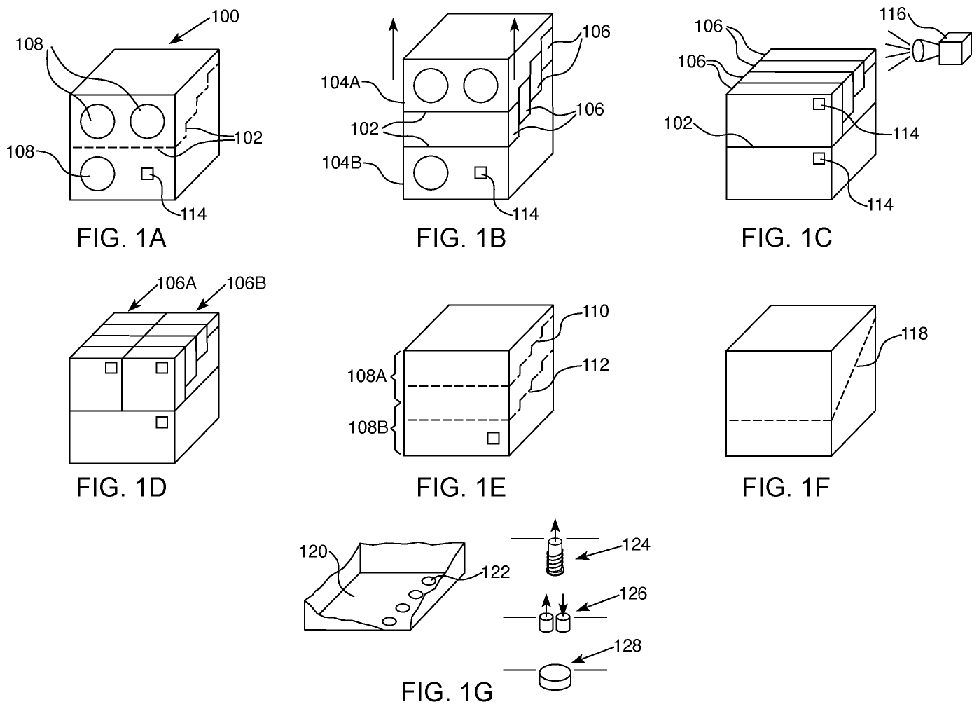

It is noted at this point that the containers used for shipping, as described herein, are completely interchangeably referred to as a “shipping box” or a “shipping container”. Thus, the overall container 100 shown exemplarily in FIG. 1A, used for shipping a number of product packages (e.g., 106 in FIG. 1C), will be interchangeably described as “shipping box 100” or “shipping container 100”, with no intent to distinguish between the terminology.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

Conceptual Architecture

FIG. 1A illustrates one possible shipping box 100 configuration according to some exemplary embodiments, as used for shipping consumer products as typically shipped in containers used for packaging and display. The shipping box 100 is made of, for example, corrugated cardboard material, and, for shipping efficiency, preferably has dimensions compatible with standard shipping pallets. As well known in the art, such shipping boxes 100 are often made of corrugated cardboard material, but the present invention should not be considered as limited to cardboard material since other materials such as plastic could also be used to form shipping containers. Additionally, as also well known in the art, such corrugated cardboard boxes are typically constructed using a single piece of cardboard involving interconnected rectangular shapes that can be bent, folded, and taped or otherwise fastened in a predetermined manner to form a box, including boxes that are totally enclosed, with top and bottom walls and four sidewalls interconnecting the top and bottom walls.

Ideally, the dimensions of the consumer product containers being shipped in the shipping box 100 would be predetermined ratios of the dimensions of the shipping box 100, preferably in all three dimensions, so that a predetermined number of consumer product containers would essentially exactly fill the interior space of the shipping box 100. Perhaps more realistically, small residual spaces may exist even if the shipping box 100 is completely filled with consumer product containers. Additionally, a residual space might exist if a shipment is ordered in quantity less than that would completely fill a standard sized shipping box 100. A filler material such as crumbled newspaper or other packing filler material such as spacers formed by layers of cardboard could be used to fill any residual space in any specific shipping box 100.

As exemplarily shown in FIG. 1A, the shipping box 100 has a predetermined pattern of perforations 102 intended to permit the top of the shipping box 100 to be removed (see FIG. 1B) to permit visibility of the enclosed consumer product containers. Thus, the present invention provides a method to use the shipping box 100 as a convenient mechanism to display the enclosed consumer products on display shelves in a retail store by zipping off and removing a predetermined amount of top cardboard material 104A, as exemplarily shown in FIG. 1B, while leaving the bottom portion 104B sufficiently intact to securely contain the product packages 106 while also permitting these product packages 106 to be seen and accessible for removal by customers. Using such shipping boxes also provides efficiency in stocking shelves in retail establishments having large quantities of consumer products, such as large retailers such as Walmart or Costco or specialty retailers such as drug stores or home supply retail stores, since the shipping boxes can be directly moved onto display shelves for display to consumers.

It should also be clear that the shipping boxes 100 of the present invention would also provide efficiency in an automated inventory control system, not only in retail stores but also in other scenarios. For example, large distribution centers such as used for online sales retailers such as Amazon or regional parts supply centers would also clearly be more efficient if their products were to be delivered from suppliers using the shipping boxes 100 of the present invention. In addition to efficient storage, an efficient inventory management system is possible by simply monitoring the number of units of product remaining in the shipping box 100, and, preferably, such monitoring could be automated, using various mechanisms as further described herein.

The shipping boxes 100 of the present invention are also intended as potentially used in fully automated environments in which robots are used in a distribution or storage areas to place the shipping boxes 100 on shelves or in storage, to remove the tops of the shipping boxes 100 as required for access and/or display, and possibly even to remove specific consumer product containers from the shipping boxes 100 as required to fulfill a customer order.

FIG. 1C shows exemplarily a shipping box 100 with its top removed according to its predetermined perforations 102, revealing the product packages 106 that have been shipped in this container. These perforations 102 would readily permit the top of the shipping box 100 to be removed manually by an employee, for example, by using a knife or other edged cutting tool if the perforations are presented in a single line of perforation holes or by zipping off a tab if the perforations are presented as two parallel lines of perforation holes so that the cardboard between the two lines of perforated holes can be easily torn away from the shipping box. However, it is noted that the present invention also envisions that the shipping box perforations 102 are also intended as mere external markings rather than a line of pre-cut perforations, the external markings serving as a guide for an employee to cut the cardboard material along the external mark to remove the top of the box or that permit an automated agent such as a robot to remove the tops of shipping boxes using one or more tools under robotic control.

Returning again to FIG. 1A, in some exemplary embodiments, the shipping box 100 of the present invention is also intended as including holes 108 in the cardboard material, as intended to save weight of cardboard material used to construct the shipping box 100 and, in some packaging scenarios, to provide ventilation for contents being shipped such as, for example, produce, or even as viewing holes for inspections of verifying internal contents of the shipping box 100 without having to tear open the box 100. Such holes 108 would be predetermined in size and location to take into account structural integrity of the shipping box 100 as fulfilling its shipping, storage, and display functions, including any additional structural requirements such as stacking of shipping boxes 100 on top of each other and routine handling of boxes being moved, including perhaps having to move the shipping box 100 off a pallet that was used for shipping. In some exemplary embodiments, the shipping container 100 could be reinforced at, for example, each vertical corner of the shipping container 100 could have cardboard stiffeners (not shown in the figures) affixed to the vertical corner edges to reinforce the container 100 for stacking and/or for purpose of serving as spacers for product packages being shipped in the container 100, and such stiffeners could also be used in one or more of remaining corners if necessary for reinforcement in any of the horizontal axes of the box 100 and/or spacers for product boxes.

As shown in FIG. 1C, the product packages 106 comprise a plurality of packages (e.g., four are exemplarily illustrated) that, in this example, substantially entirely fill the vertical dimension of the shipping box. Although FIG. 1C exemplarily shows the length dimension of each product package 106 as substantially filing the width of the shipping box 100, it should be clear that the product packages 106 might be sized so that a plurality of product packages (i.e., two or more) can fit into the width dimension of the shipping box 100, as exemplarily shown in FIG. 1D, which shows how the product packages are sized to fit within the shipping box as two columns 106A, 106B.

Similarly, as exemplarily shown in FIG. 1E, the shipping box 100 could contain multiple layers of product packages such as two layers 108A, 108B shown in this figure. In such cases, the shipping box 100 could have corresponding multiple perforation lines 110, 112, which typically would include one perforation line per layer of product packages in the shipping box 100.

Although FIG. 1A-FIG. 1E exemplarily shows the perforated patterns as having a stair-step design that correlates to the shape of the product packages 106 inside the shipping container, this is only one possible pattern, since other patterns would also permit visibility and accessibility to the internal product packages 106. FIG. 1F shows a simple diagonal pattern 118 that would provide the functions of visibility and accessibility of the stored product packages 106, and many other perforation patterns could be used.

As exemplarily shown in FIG. 1C and FIG. 1D, the number of product units remaining in the shipping container is readily ascertainable once the top is removed, by a visual inspection, and that such inspection could be done by having an inspector look at the container to determine the number of product units remaining. To assist this inventory process, the shipping container has affixed thereto at least one product identification (ID) marker 114, such as a bar code, QR code, RFID code, etc., as is well known in the art, and a shipping container may have more than one such ID marker, in multiple locations on the container. In FIG. 1C, the product packages 106 also each has the product ID marker 114. The product ID markers 114 may include additional information such as serial numbers, manufacturing information, etc. The number and location(s) of the product ID markers on the shipping container 100 would preferably be standardized based on which portion(s) of the container remains after a predesigned portion(s) of the container is removed to permit access and visibility of the internal contents.

To automate inventory processing to detect the number of product packages remaining in a shipping container 100, a number of mechanisms could be used. For example, as exemplarily shown in FIG. 1C, a video camera 116 system could provide images of shipping boxes 100, and routine image analysis processing of these images could detect the number of remaining packages. The video camera(s) 116 could be stationary or could be movable in one or more axes, including rotary movements. Additionally, the video camera 116 could be incorporated in a moving vehicle, including, for example a flying drone or a wheeled vehicle that could autonomously move among isles of display racks or be controlled by a human operator. In some exemplary embodiments, the product ID markers 114 could be detected as part of the image analysis processing. In other exemplary embodiments, the product ID markers 114 could be read using a sensor specific for the different possible ID marker types. For example, a bar code or QR code might require a dedicated scanner sensor separate from the video camera 116 system.

Along this line, in some exemplary embodiments, the ID markers might be on the rear surface of the shipping box 110, if the sensors for detecting the content identification are mounted on a wall on the rear side of the shipping box 100, or a sensor could even be mounted on the floor or shelf below the shipping container 100, so that the product ID marker would be placed on the bottom surface of the shipping container 100.

FIG. 1G shows another possible automatic inventory sensing mechanism in which the bottom wall 120 of a shipping container 100 has a plurality of holes, each corresponding to position normally occupied by a product package. For example, FIG. 1G shows a possible configuration of four holes 122 corresponding to the four packages 106 shown in FIG. 1C. Whenever one of the four product packages 106 is removed, a spring-loaded plunger 124 would serve as a proximity sensor and serve as an actuator for an associated switch or relay, which in turn sends a signal to indicate the missing package, and the number of remaining packages would clearly be indicated by the number of plunger/switches that have not been activated.

A similar sensing mechanism could be achieved if the four holes 122 of FIG. 1G were respectively associated with other types of proximity detectors. For example, four LED emitter/receiver circuits 126 could be used to periodically monitor if any of the four product packages 106 have been removed from the shipping box. Other sensing mechanisms could also be used, for example, based on weight. Thus, for example, one or more piezoelectric sensor circuits 128 could be placed below each shipping box to sense the current weight of the shipping box with its remaining product containers 106 or bulk produce, or could be placed below the expected position of each product package 106 within the shipping box 100.

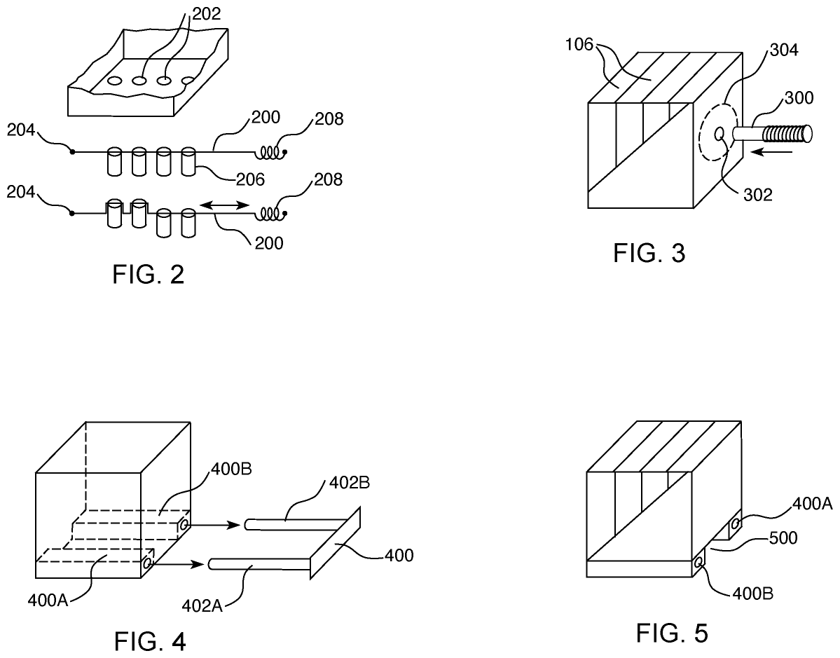

FIG. 2 shows a possible low-tech variation in which a sensor system using a string or wire 200 that is spring-loaded and strung along the bottom surface exemplarily having four holes 202, one under corresponding product package positions. The string 200 is attached at one end 204 and is threaded through grooves on the top surface of spring-loaded plungers 206 located in the shelf or floor under the shipping container, and the shipping box is then placed on top of the string 200/plungers 206. Subsequent removal of a consumer product container causes the string or wire to be pushed up into an opening by a plunger 210 whenever a consumer product container is removed from the shipping box. If the string/wire 200 is maintained under tension by a spring 208, then the amount of tension in the spring 208, indicated by how far the spring 208 is stretched when the various spring-loaded plungers 206 are pushed through their corresponding opening 202 would indicate how many consumer product containers have been removed.

In any of the above-identified examples of automatically detecting the number of units remaining in a shipping box, it is noted that the sensing circuit need only be activated periodically, rather than continually monitoring the system, in order to maintain an automatic inventory system using the present invention.

FIG. 3 shows yet another mechanism related to the packing concepts of the present invention. In this concept, a plunger 300 is used to automatically push the remaining product packages 106 toward the front of the shipping box as the front product package 106 is removed. The number of remaining product packages 106 is easily determined by measuring how far the plunger 300 has moved.

The plunger 300 might be spring-loaded, as suggested in FIG. 3, or could be driven by another mechanism such as an electromagnetic drive mechanism Although FIG. 3 shows a single plunger 300, there could be multiple plungers. FIG. 3 also shows the plunger as operating through a pre-cut hole 302 in the back wall of the shipping box, but other configurations are clearly possible. For example, perforation markings 304 on the back wall of the shipping box could indicate that a portion of the back wall could be removed so that a larger plate attached to the plunger 300 would enter through the opening of the removed portion to more uniformly press against the backside walls of the product packages 106, or the portion of the back wall of the box that is enclosed by a circular perforation 304 that has been cut could simply be left in place, to serve as a broader surface for plunger 300 to push on.

FIG. 4 and FIG. 5 show yet another possible variation related to the packing concepts of the present invention. In this variation, instead of resting a shipping container 100 on a display shelf or on the floor of a display area, the shipping container 100 is modified to incorporate channels 400A, 400B of reinforced cardboard or plastic material so that the shipping box 100 can be slid onto rods 402A, 402B protruding from a wall or mounting rack, thereby eliminating the conventional shelf. FIG. 4 shows the two channels 400A,400B as formed inside the shipping box 100, and FIG. 5 shows the two channels 400A, 400B as formed outside the shipping box 100.

Of course, it should be clear that such modified shipping boxes 100 could also be placed on top of a conventional shelf or on the floor or ground if desired. It should also be clear that, although FIG. 4 and FIG. 5 shows two channels 400A, 400B and two protruding rods 402A, 402B, more than two channels could be formed in a shipping box 100, to mate up with a corresponding number of rods protruding from a wall or rack in a display area.

An advantage of this variation is that such racks 404 with protruding rods could be more convenient than shelves that are built into a wall or display rack in a display area, and such racks with protruding rods could be build with wheels that permit them to be moved as desired in a display or storage area. Another advantage of such racks if moveable is that these moveable racks could even be used as a transportation mechanism to move shipping containers 100 from a storage area into a display area.

Similarly, such shipping containers 100 with channels 400A, 400B on their bottom surface could be handled using forklifts if the lift forks can slip into the reinforced channel openings, thereby permitting such shipping containers 100 to be moved from a storage area to a display area without having the shipping box 100 mounted on a shipping pallet. An advantage of having the channels 400A, 400B on the outside of the shipping box is that, even if the lift forks of a forklift do not slip into the channel openings, the lift forks would slip into the gap 406 formed between the channels 400A, 400B.

Accordingly, it should be clear that modifying shipping boxes 100 to have reinforced channels 400A, 400B on the bottom surface of the shipping box 100 could be used as a mechanism that potentially eliminates the need for using shipping pallets for such shipping boxes 100, and such freedom from shipping pallets would also mean that such modified shipping boxes 100 could be sized independently of the standard sizes of shipping pallets.

Additionally, freeing the shipping boxes 100 from the need to use shipping pallets would not only save weight in shipping but would also permit efficient packing of shipping boxes 100 without losing shipping area due to shipping boxes 100 that do not take up the entire area of a standard shipping pallet.

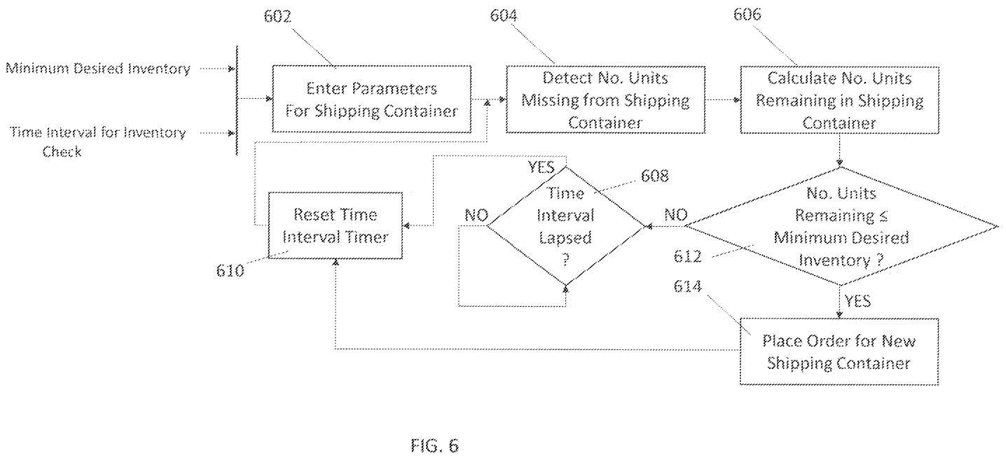

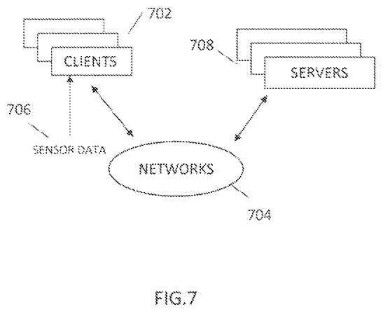

FIG. 6 provides an exemplary flowchart of steps implemented in an automatic inventory system using any of the sensing mechanisms described above. Thus, as shown in FIG. 6, for each consumer product type or category in the automated inventory system, in step 602, parameters related to that consumer product are initially entered into the automated system. In step 604, the number of units of consumer product containers that have been removed from a shipping box is detected so that, in step 606, the number of remaining units can be calculated. As mentioned, this detection of removed units and calculation of remaining units could be done using predetermined time intervals, rather than continuous monitoring of all detectors, as indicated by steps 608, 610. In steps 612, 614 the system can automatically place an order for consumer products having the remaining number of units that fall at or below a predetermined number to be maintained in inventory for that specific product. It should be clear that step 614 could also implement other actions such as issuing a warning to system operators that the inventory level for this product has reached a predetermined minimal threshold or that step 614 issues only a warning but does not automatically place an order for replacement products.

Along the lines of traditional inventory control such as described in FIG. 6, it is noted that the present invention has the potential for blockchain inventory integration of the product in the container, aiding autonomous purchasability and traceability. The automatic inventory detection provided by the container allows for autonomous blockchain inventory control as well as creates a mode for product—in case-to-marketplace—purchasability regardless of retailer/seller as it could be done, for example, through a crypto-wallet using ethereum via a Loopring-based application. A product could then be searchable and purchasable by product type in the marketplace, instead of only by retailer, and via blockchain integration of the container the information integrity is accurate to the case unit of product regardless of location.

FIG. 7 exemplarily shows a computer architecture that supports an embodiment of the invention in which the shipping boxes are integrated into an automatic inventory system. Client device(s) 702 include, generally, a computer or computing device including functionality for communicating (e.g., remotely) over a network 704. Inventory sensors associated with shipping boxes collect inventory data 706 and provide such data into one or more client devices 702 that implement the inventory processing described by the flowchart in FIG. 6. Automatic reorders for products (step 614 of FIG. 6) are implemented by transmitting an order request from a client machine 702 to a remote server 706 via network 704. The remote servers 706 receiver reorder requests, process such reorder requests, and route the request to the appropriate supplier of the desired product. The supplier would receive and process the reorder request from the server 706 and implement the requested reorder shipment. Client device(s) 706 may be a server, a desktop computer, a laptop computer, personal digital assistant (PDA), among other suitable computing devices. Client devices 706 may execute one or more client applications, such as a web browser (e.g., Microsoft Windows Internet Explorer, Mozilla Firefox, Apple Safari, Google Chrome, and Opera, etc.), or a dedicated application to submit user data, or to make prediction queries over a network 704, and may have one or more add-ons, plug-ins, or other extensions, such as TOOLBAR or YAHOO TOOLBAR. A client device 706 may enable a user to enter a Uniform Resource Locator (URL) or other address directing the web browser to a server, and the web browser may generate a Hyper Text Transfer Protocol (HTTP) request and communicate the HTTP request to server 706. The server 706 may accept the HTTP request and communicate to the client device 702 one or more Hyper Text Markup Language (HTML) files responsive to the HTTP request. The client device 702 may render a web page based on the HTML files from server 706 for presentation to the user at the client device 702. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

Exemplary client devices are illustrated in the subsequent figure provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 704 generally represents a network or collection of networks (such as the Internet or a corporate intranet, or a combination of both) over which the various components illustrated in FIG. 7 (including other components that may be necessary to execute the system described herein, as would be readily understood to a person of ordinary skill in the art). In particular embodiments, network 704 is an intranet, an extranet, a virtual private network (VPN), a local area network (LAN), a wireless LAN (WLAN), a wide area network (WAN), a metropolitan area network (MAN), a portion of the Internet, or another network 704 or a combination of two or more such networks 704. The present disclosure contemplates any suitable network 704 and any suitable link for connecting the various systems and databases described herein.

The system may also contain other subsystems and databases, which are not illustrated in FIG. 7, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

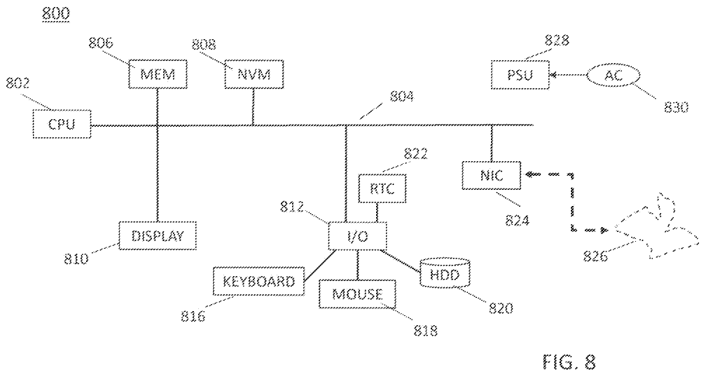

FIG. 8 shows an exemplary overview of a computer system 800 as may be used in any of the various locations throughout the system such as the client 702 or server 706 shown in FIG. 7. It is exemplary of any computer that may execute code to process data. Various modifications and changes may be made to computer system 800 without departing from the broader scope of the system and method disclosed herein. Central processor unit (CPU) 802 is connected to bus 804, to which bus is also connected memory 806, nonvolatile memory 808, display 810, input/output (I/O) unit 812, and network interface card (NIC) 814. I/O unit 812 may, typically, be connected to keyboard 816, pointing device 818, hard disk 820, and real-time clock 822. NIC 824 connects to network 826, which may be the Internet or a local network, which local network may or may not have connections to the Internet. Also shown as part of system 800 is power supply unit 828 connected, in this example, to a main alternating current (AC) supply 830. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A shipping box comprising a material sufficiently rigid to serve as a shipping container for product packages, the shipping box being shaped so as to be able to form an enclosed shipping box having a top wall, a bottom wall, and four sidewalls interconnecting the top and bottom walls,
wherein, the enclosed shipping box is configured such that the four sidewalls have at least one line of perforations predetermined to permit the top wall and predetermined top portions of the four sidewalls to selectively be removed so that portions of the shipping box remaining after the top wall and top portions of the sidewalls are removed form a display case permitting visibility and accessibility for product packages shipped using the enclosed shipping box.

2. The shipping box of claim 1, wherein the material comprises a corrugated cardboard material.

3. The shipping box of claim 1, wherein the material comprises a plastic material.

4. The shipping box of claim 1, wherein the at least one line of perforations comprises two parallel lines of perforations such that a material between the two parallel lines of perforations can be easily zipped away to remove the top wall and predetermined portions of the four sidewalls.

5. The shipping box of claim 1, wherein one or more of the top wall and the four sidewalls include openings predetermined in size and location to one or more of: reduce weight of the shipping box while still maintaining a strength of the shipping box; provide ventilation holes for contents being shipped; and serve as viewing holes for inspections of verifying internal contents of the shipping box without having to tear open the shipping box.

6. The shipping box of claim 1, as sized to hold at least two layers of product packages as intended to be sequentially removed in layers from the shipping box, wherein the four sidewalls include at least one line of perforations as associated with each of the at least two layers of product packages such that the at least one line of perforations associated with each layer permit visibility and accessibility of product packages in that associated layer of product packages.

7. The shipping box of claim 1, as having affixed thereto at least one product identification marker that identifies a product or products being held by the shipping box.

8. The shipping box of claim 1, as having included in the bottom wall, a plurality of openings at locations that match locations of proximity sensors installed on a shelf or floor supporting the shipping box, the proximity sensors detecting which product packages still remain in the shipping box.

9. The shipping box of claim 1, wherein the bottom wall include channels that permit the shipping box to be mounted to rods protruding from a wall or display rack.

10. A method of displaying product packages or produce in a display area, the method comprising:
moving the product packages or produce in the display area in a shipping box that was used for shipping the product packages or produce to a location of the display area, the shipping box forming an enclosed shipping box having a top wall, a bottom wall, and four sidewalls interconnecting the top and bottom walls, and the enclosed shipping box being configured such that the four sidewalls have at least one line of perforations predetermined to permit the top wall and predetermined top portions of the four sidewalls to selectively be removed so that portions of the shipping box remaining after the top wall and top portions of the sidewalls are removed form a display case permitting visibility and accessibility for product packages shipped using the enclosed shipping box; and
removing the top wall and predetermined top portions of the four sidewalls in accordance with the at least one line of perforations thereby permitting the product packages or produce to be visible and accessible to be removed from the shipping box.

11. The method of claim 10 of displaying product packages or produce, wherein the display area is located in one of:
a retail environment in which customers can remove an item from the shipping box for purchase; and
a distribution center in which agents select an item from the shipping box to be sent to customer in accordance with an online order.

12. The method of claim 10, wherein the shipping box contains a plurality of layers of product packages and wherein each layer of product packages is associated with at least one line of perforations thereby permitting the product packages its associated layer to be visible and accessible to be removed from the shipping box, the method further comprising sequentially exposing, when all product packages of a top layer are removed from the shipping box, a new layer of product packages by removing portions of the sidewalls in accordance with the perforations of its associated line of perforations.

13. The method of claim 10, wherein the at least one line of perforations comprise two parallel lines of perforations such that a material between the two parallel lines of perforations can be easily zipped away to remove the top wall and predetermined portions of the four sidewalls.

14. The method of claim 10, further comprising utilizing at least one sensor system to automatically detect a number of product packages or an amount of produce remaining in the shipping box.

15. The method of claim 14, wherein each shipping box holding product packages or produce in the display area has affixed thereto an identification marker that identifies contents contained in that shipping box, the method further comprising: for each shipping box in the display area, reading a content of the identification marker affixed to that shipping box; and maintaining an automatic inventory system using the detected number of product packages or an amount of produce remaining in that shipping box.

16. An automated inventory system in one of a retail shopping environment and a distribution center satisfying online orders, the system comprising:
a computer system to receive and maintain inventory data;
a plurality of shipping boxes, each of which was used to ship either a plurality of product packages or produce to the retail shopping environment or distribution center and, when opened, is used in the retail shopping environment or distribution center as display containers for items shipped therein; and
one or more sensors detecting and providing as inventory data to the computer system a number of remaining product packages or an amount of remaining produce in each of the shipping boxes used as display containers,
wherein each of the shipping boxes as a shipping box for items being shipped therein comprised an enclosed shipping box having a top wall, a bottom wall, and four sidewalls interconnecting the top and bottom walls, the four sidewalls having at least one line of perforations predetermined to permit the top wall and predetermined top portions of the four sidewalls to selectively be removed so that portions of the shipping box remaining after the top wall and top portions of the four sidewalls are removed to open the shipping box to form a display case permitting visibility and accessibility for products that were shipped using the enclosed shipping box.

17. The automated inventory system of claim 16, wherein the sensors providing inventory data to the computer system comprise one or more of:
a system of one or more video cameras that provide image data of the display containers to the computer system and the computer system detects the number of product packages or amount of remaining produce using an image analysis processing of the image data;
a plurality of proximity sensors, each proximity sensor being associated with a product package in a display container and indicating whether its associated product package still remains in the display container; and
a plurality of weight sensors, each weight sensor being associated either with a product package in a display container and indicating whether its associated product packet still remains in the display container or with a display container displaying produce and indicating an amount of produce still remaining in the display container.

18. The automated inventory system of claim 16, wherein each of the display containers have affixed on an outer surface thereof an identification marker that identifies contents contained in that display container, and wherein sensors detect information on the identification markers as inventory data reported to the computer system.

19. The automated inventory system of claim 16, wherein one or more of the display containers contains a plurality of layers of product packages and wherein each layer of product packages is associated with at least one line of perforations thereby permitting the product packages in its associated layer to be visible and accessible to be removed from the shipping box,
the method further comprising sequentially exposing, and wherein, when all product packages of a top layer are removed from the display container, a new layer of product packages by removing portions of the sidewalls in accordance with the perforations of its associated line of perforations.

20. The automated inventory system of claim 16, wherein the at least one line of perforations comprise two parallel lines of perforations such that a material between the two parallel lines of perforations can be easily zipped away to remove the top wall and predetermined portions of the four sidewalls.
